(19) United States
(12) Patent Application Publication
(10) Pub. No.: US 2006/0108973 A1
(43) Pub. Date: May 25, 2006

(54) Apparatus to identify battery manufacturer

(75) Inventor: Hung-Hao Shi, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/284,700

(22) Filed: Nov. 22, 2005

(30) Foreign Application Priority Data
Nov. 24, 2004 (CN) 200410052434.2

(51) Int. Cl. H02J 7/00

(52) U.S. Cl. 320/106; 320/137

(57) ABSTRACT

An apparatus to identify the manufacturer of a battery is provided, the battery typically includes a DC signal pin and a grounding resistor. The apparatus includes a keyboard controller. The keyboard controller includes an analog to digital converter (ADC) with an ADC signal pin. The ADC signal pin is connected to an end of the grounding resistor through the DC signal pin, and the other end of the grounding resistor is grounded. It is of advantage that the DC signal pin of the battery is coupled to the ADC signal pin of the keyboard controller. The voltage of the DC signal pin is converted into a multi-bit digital signal to compare with a list programmed in the keyboard controller, to identify any of a large number of various different battery manufacturers.

### BACKGROUND OF THE INVENTION

1. Field of the Invention

The present invention relates to an apparatus to identify a manufacturer of parts of an electronic device, like a battery of a notebook.

2. General Background

In recent years, information processing apparatuses have decreased in size. Portable information processing equipment hand-carriable by users, such as notebook personal computers, have become more important in the market and are in wide spread use in modem business. In circumstances where AC power is not available, the information processing equipment including notebook computers is electrically driven by rechargeable batteries loaded therein. The battery manufacturer is identified by a keyboard controller mounted on a motherboard of the notebook. A list of the manufacturers of the battery is established in the keyboard controller. Referring to FIG. 2, an I/O pin D0 of a keyboard controller 1 is connected to a terminal of a grounding resistor R1 of a battery 3 via a signal pin DC of the battery 3. The I/O pin D0 is also coupled to a voltage terminal V1 of a motherboard via a resistor R3. The other terminal of the grounding resistor R1 is grounded. The value of the resistor R3 is 10 kiloohms. The input voltage of the I/O pin D0 vary because the different battery manufacturers provide different resistor values for the grounding resistor R1. The keyboard controller 1 identifies the battery's manufacturer according to the voltage input at pin D0.

However, the keyboard controller 1 can only identify two types of voltage; that is, high voltage and low voltage. High voltage is defined as 2.4V, low voltage is defined as 0.4V, and the allowance for noise is 0.4V. Therefore, when the input voltage is between 2V and 2.4V, the voltage at I/O pin D0 is identified as high voltage. When the input voltage is between 0.4V and 0.8V, the voltage at I/O pin D0 is identified as low voltage. However, there are many battery manufacturers whose batteries register a voltage at I/O pin D0 that falls out side the two defined ranges and thus are unidentifiable. Only two classes of battery manufacturers in the range of high voltage and low voltage can be identified.

What is needed is an apparatus to accurately identify a large number of various different battery manufacturers.

### SUMMARY

An apparatus to identify the manufacturer of a battery is provided, the battery typically includes a DC signal pin and a grounding resistor. The apparatus includes a keyboard controller. The keyboard controller includes an analog to digital converter (ADC) with an ADC signal pin. The ADC signal pin is connected to an end of the grounding resistor through the DC signal pin, and the other end of the grounding resistor is grounded.

It is of an advantage that the DC signal pin of the battery is coupled to the ADC signal pin of the keyboard controller. The voltage of the DC signal pin is converted into a multi-bit digital signal to compare with a list programmed in the keyboard controller, to identify any of a large number of various different battery manufacturers.

Other advantages and novel features will become more apparent from the following detailed description when taken in conjunction with the accompanying drawings, in which:

### BRIEF DESCRIPTION OF THE DRAWINGS

FIG. 1 is a block diagram of an apparatus to identify a battery's manufacturer in accordance with a preferred embodiment of the present invention, the apparatus being connected with a battery; and

FIG. 2 is a block diagram of a conventional apparatus to identify a battery's manufacturer, the apparatus being connected with a battery.

### DETAILED DESCRIPTION OF THE EMBODIMENT

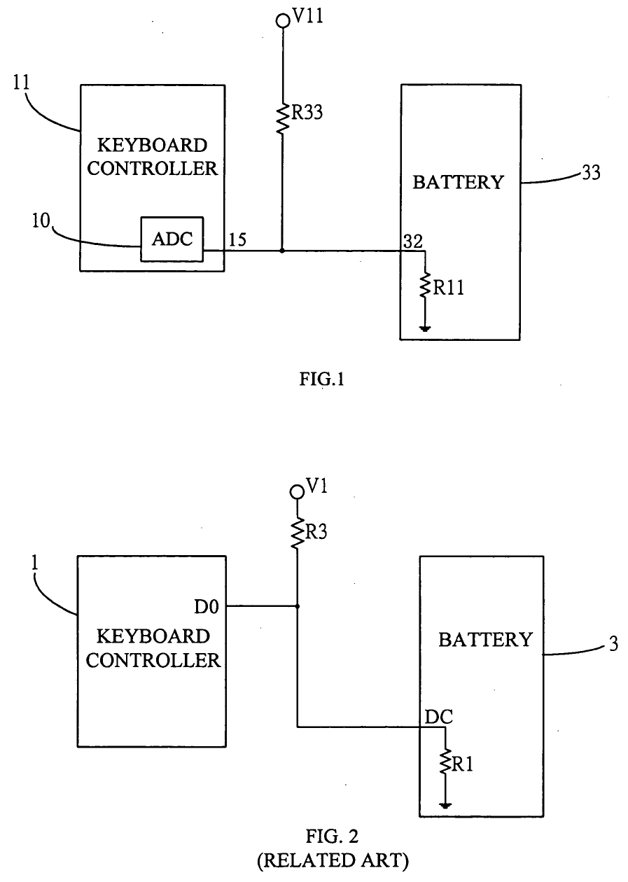

Referring to FIG. 1, an apparatus to identify the manufacturer of a battery 33 includes a keyboard controller 11. The battery 33 typically includes a DC signal pin 32 and a grounding resistor R11. The keyboard controller 11 includes an analog to digital converter (ADC) 10, and the ADC 10 includes an ADC signal pin 15. The ADC signal pin 15 is connected to an end of the grounding resistor R11 through the DC signal pin 32. The other end of the grounding resistor R11 is grounded. The ADC signal pin 15 is also coupled to a voltage terminal V11 via a resistor R33.

Batteries from different manufacturers have grounding resistors R11 of different values resulting in different voltage values at the ADC signal pin 15. The value of the grounding resistor R11 is typically in the range from 10 ohms to 10 kiloohms. The ADC 10 is an 8-bit analog to digital converter, and can convert the analog voltage at the ADC signal pin 15 into an 8 bit digital signal. Therefore, the ADC 10 can identify 256 (2⁸) different signal values. In the keyboard controller 11, the digital signal is compared with a manufacturer's list programmed in the keyboard controller 11, to identify the battery's manufacturer. Thus, the number of identifable battery manufacturers is as many as 256.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. An apparatus to identify the manufacturer of a battery, the battery comprising a DC signal pin and a grounding resistor, the apparatus comprising:
a controller, the controller comprising an analog to digital converter (ADC) with an ADC signal pin;
wherein the ADC signal pin is for connecting to an end of the grounding resistor through the DC signal pin, with the other end of the grounding resistor being grounding.

2. The apparatus as claimed in claim 1, wherein the ADC signal pin is coupled to a voltage terminal via a resistor.

3. The apparatus as claimed in claim 1, wherein the ADC is an 8-bit analog to digital converter.

4. The apparatus as claimed in claim 1, wherein the apparatus can detect a value of the grounding resistor that is anywhere in the range from 10 ohms to 10 kiloohms.

5. The apparatus as claimed in claim 4, wherein the value of the grounding resistor corresponds to the manufacturer of the battery.

6. A method for identifying a battery's manufacturer, the battery comprising a DC signal pin and a grounding resistor, the method comprising:
providing a controller including an analog to digital converter (ADC) with an ADC signal pin;
connecting the ADC signal pin to an end of the grounding resistor through the DC signal pin; and
coupling the other end of the grounding resistor to the ground.

7. The method as claimed in claim 6, further comprising the step of coupling the ADC pin to a voltage terminal via a resistor.

8. The method as claimed in claim 6, wherein the ADC is an 8-bit analog to digital converter.

9. A method for identifying manufacturers of parts of an electronic device, comprising the steps of:
retrieving identifiable voltage signals for predetermined corresponding manufacturers from parts of an electronic device made by said manufacturers;
converting said voltage signals to corresponding digital signals; and
identifying said manufacturers according to said corresponding digital signals.

10. The method as claimed in claim 9, wherein an analog to digital converter (ADC) is used to convert said voltage signals in said converting step.

11. The method as claimed in claim 9, wherein said identifiable voltage signals from said parts of said electronic device are decided by resistors having predetermined resistance values installable in each of said parts of said electronic device respectively.
